(19) United States
(12) Patent Application Publication
(10) Pub. No.: US 2008/0305307 A1
(43) Pub. Date: Dec. 11, 2008

(54) Deep "C" parts and method of molding

(75) Inventor: Hiroaki Yamamoto, Nagoya (JP)

Correspondence Address: WEGMAN, HESSLER & VANDERBURG, 6055 ROCKSIDE WOODS BOULEVARD, SUITE 200, CLEVELAND, OH, 44131, US

(73) Assignee: Green Tokai Co., Ltd., Brookville, OH (US)

(21) Appl. No.: 12/228,212

(22) Filed: Aug. 11, 2008

Related U.S. Application Data
(63) Continuation of application No. 10/572,733, filed on Jan. 12, 2007.
(60) Provisional application No. 60/505,459, filed on Sep. 24, 2003.

(51) Int. Cl. B32B 1/00

(52) U.S. Cl. 428/174; 264/259

(57) ABSTRACT

An elongated, substantially “C” cross sectioned part and method of making same are provided wherein the part may be injection molded and covered with a paint film on the showside part portions. The method includes the provision of a mold cavity having an inclined nadir wall boundary and moving the female mold away from the stationary male mold part an angle of about 1-20° relative to the widthwise or Y direction. The part includes a plastic substrate and an optional paint film having one edge thereof terminating along the nadir wall behind the show surface of the part.

### CROSS-REFERENCE TO RELATED APPLICATIONS

This application is a continuation application of Ser. No. 10/572,733 which was a United States national phase filing under 35 USC §371 of International PCT Application No. PCT/US2004/028991 having an international filing date of Sep. 7, 2004 and claiming the priority benefit of U.S. Provisional Patent Application Ser. No. 60/505,459 filed Sep. 24, 2003.

### BACKGROUND OF THE INVENTION

1. Field of Invention

This invention relates to deep “C” cross-section molded parts and methods of making such parts.

2. Description of Related Art

Automotive trim parts and protective molding are often prepared via injection molding techniques with the manufacture of elongated moldings being greatly aided by gas assisted injection molding techniques. For some applications, it is desirable to form deep drawn molded parts wherein the transverse cross section of the elongated part approximates the letter “C”.

For example, it is desirable to provide deep drawn side sill and rocker panel moldings for automobiles, for example, wherein the exterior show surface of the part (i.e., the outer part surface between the opposed generally horizontal ends of the “C”) extends generally transverse to a bisecting axis of the part between the opposed ends of the “C”. A paint film is often incorporated on the show surface side of the part to provide a desired aesthetic appearance of the part due to the color and gloss qualities of the paint film on the part. Such paint films are commercially available and are typically unwound from a roll, cut to a desired size and shape, and placed in mold cavity with the painted or aesthetically pleasing side of the film facing the outer mold cavity surface. Molten resin is then injected into the mold cavity to form the part with the paint film in place. After cooling, the part is ejected from the mold cavity.

Techniques for preforming paint films and insert or co-molding of the paint film and substrate are disclosed, for example, in U.S. Pat. Nos. 5,599,608 (Yamamoto et al.); 5,746,962 (Yamamoto); 5,759,477 (Yamamoto); 5,783,287 (Yamamoto et al.); 5,968,444 (Yamamoto); 6,168,742 (Yamamoto); and 6,227,319 (Hardgrove et al.). The disclosures of these patents are incorporated by reference herein.

Molding of such deep drawn substantially “C” cross sectioned plastic parts, in particular, is difficult however. If the opposed edges of the “C” converge too greatly toward each other, it is difficult to remove the part from the mold cavity. Moreover, removing of the part from the mold often results in tearing, rippling or other displacement of the film that is disposed along the show surface of the part. Undesirable distortions or damage of the opposed edges of the part may also occur during removal of the part from the mold cavity. As a result, the color, gloss or other finish qualities of the part may be impaired.

### SUMMARY OF THE INVENTION

In accordance with the method, an elongated automotive part is provided via traditional molding techniques. The mold cavity comprises a nadir cavity section, an apex cavity section and a major surface cavity section. The major surface cavity section is provided with a front showside portion and an opposed rear portion. The nadir cavity section, apex cavity section and major surface cavity section together roughly define the shape of a “C”.

The mold cavity is congruent with the desired “C” cross section of the part and extends along a longitudinal axis, referred to as the Z direction and the mold cavity and resulting parts include a horizontal direction Y and a vertical direction X with the X, Y and Z directions being perpendicularly related to each other.

The nadir cavity section of the mold comprises an inclined portion as measured from the front boundary of the bottom inclined wall to the rear boundary. This inclination is set at a desired angle of from about 1-20°, relative to a tangent that touches the forward boundary of the bottom wall of the nadir cavity and extends rearwardly in the Y direction in perpendicular relation to the X direction.

Additionally, the female mold member of the mold is withdrawn from the stationery male mold member at an angle of from about 1-20°, similar to the angle of the inclined bottom wall of the nadir section. This helps to minimize pinching, rippling, or tearing of the edge of a paint film that is disposed in the nadir cavity during ejection or removal of the part from the mold.

The elongated automotive part of the invention is characterized by having an inclined nadir wall with paint film covering at least a portion of the wall. This nadir wall is provided at an incline relative to the tangent line, as set forth above.

### BRIEF DESCRIPTION OF THE DRAWINGS

Various exemplary embodiments of the systems and methods of this invention will be described in detail with reference to the following figures, wherein:

FIG. 1 is a perspective view of an automobile including a side sill garnish part made in accordance with the invention;

FIG. 2 is a transverse cross-sectional view of a prior art mold structure typically used to make a deep “C” shaped part;

FIG. 2A is a magnified cross-sectional view of a portion of the mold structure shown in FIG. 2 circumscribed by the circle marked in phantom lines as 2A in FIG. 2;

FIG. 3 is a transverse cross-section of a mold structure used in accordance with the invention;

FIG. 3A is a magnified view of the mold structure shown in FIG. 3 circumscribed by the circle marked in phantom lines as FIG. 3A in FIG. 3; and

FIG. 4 is a perspective view of an elongated part made in accordance with the invention.

### DETAILED DESCRIPTION OF THE PREFERRED EMBODIMENTS

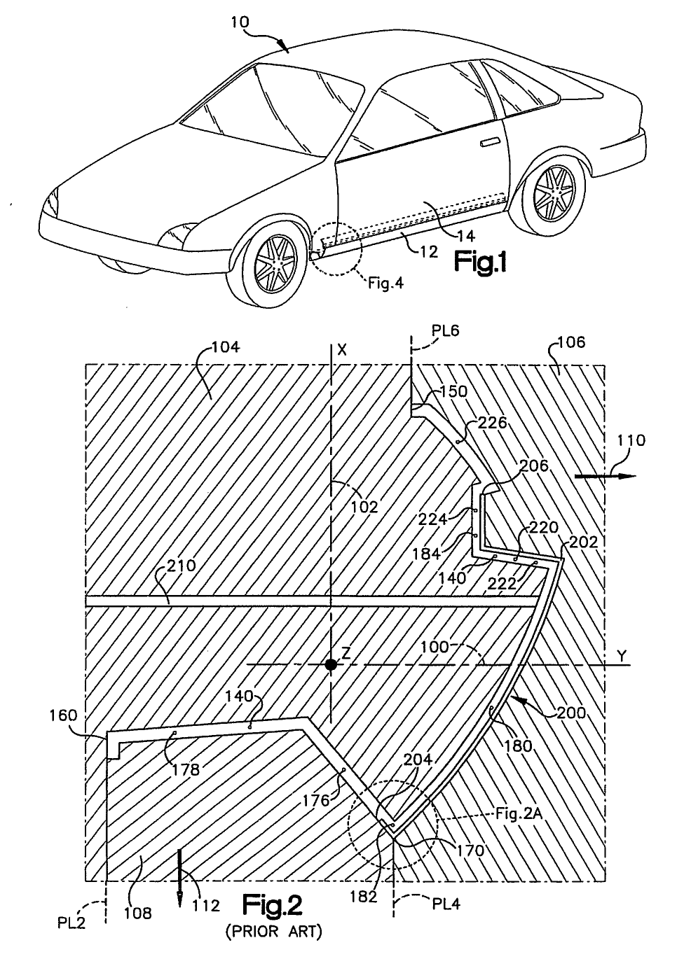

Turning first to FIG. 1, there is shown an automobile 10 of the type in which elongated part 12 in accordance with the invention may be used. As shown, part 12 is a side sill garnish or as sometimes referred to, a rocker panel. An upper portion of the part 12 is hidden by the contiguous body member or other trim member 14.

As shown in FIG. 4, the part 12 comprises an elongated member composed of a major showside surface area 406 that is located intermediate nadir wall 400 and apex wall components 402, 404. Paint film 200 covers the entirety of the major showside surface 406. A bottom edge or extremity 204 of the paint film is located along nadir wall 400 behind the nadir of the part. Legs 176 and 178 extend rearwardly spaced from the show surface of the part. A top edge of the paint film 206 is positioned on the outer surface of the part along apex wall component 404.

As shown, the part includes a Z direction, namely the longitudinal axis of the part, along with an X and Y dimension covering the height and width respectively of the part. X, Y and Z are perpendicular to each other. Overall, the shape is of a substantial backward “C” (or “C” if one were viewing the part from the right hand side of the drawing) wherein the “C” is defined by the nadir wall, apex wall, and major surface contours. Normally, the apex wall component 402 is connected to an auto frame and is hidden from sight by provision of an overlying or superposed part or trim member. Leg 178 along the bottom side of the part is also connected to appropriate framing or such. The observer will be able to see all of the surface 406. Since the bottom edge 204 of the paint film extends behind the major surface 406 along the nadir wall 400, the observer will see no break or “wavy” line that, in some other prior art parts, may appear. Similarly, because the top edge 206 of the paint film is hidden from the observer as it is covered by another part such as shown in FIG. 1, the observer will be unable to detect the boundary line created by this.

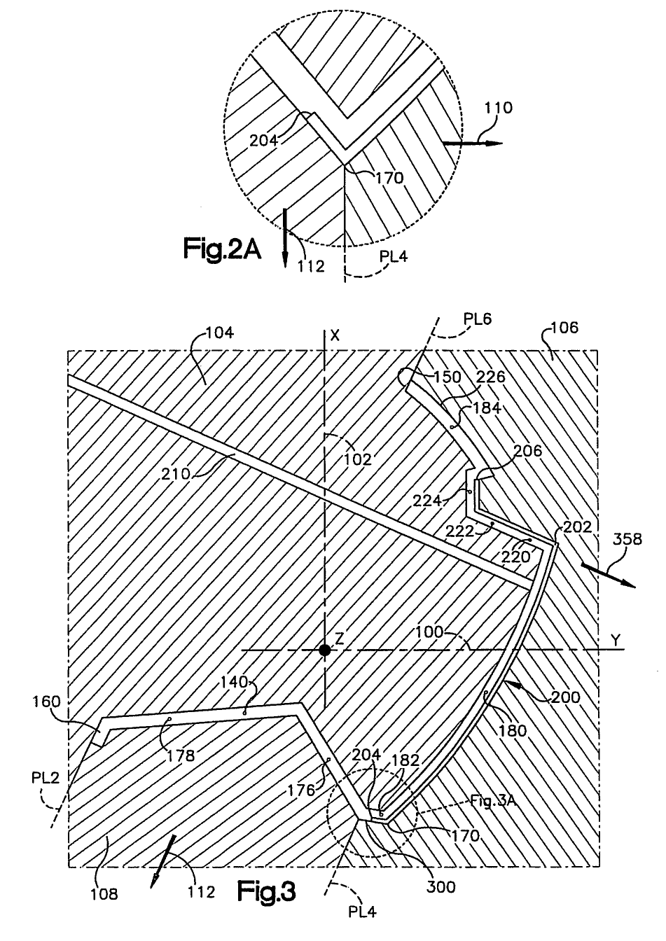

FIGS. 2 and 2A depict a typical prior art mold structure that may be utilized to mold a prior art paint film covered “C” shaped part. As shown, the Y or width dimension of the mold cavity is shown at 100 with the height or X dimension of the cavity shown at 102. The Z dimension is shown by the appropriate point Z located along the X and Y lines and, as should be understood, extends out from the plane of FIG. 2. Accordingly, the X, Y and Z dimensions are perpendicularly related one to another.

The mold structure comprises a stationary male mold part 104, a female mold part 106 which is movable in the Y direction, and a slider section 108 of the mold that can move in the X direction. The vector corresponding to movement or draft of the female mold member away from the male mold member is shown at 110 with the vector representative of the slider movement away from the male mold member being shown at 112.

A mold cavity 140 is provided between the respective male, female and slider portions of the mold structure. The mold cavity terminates at an apex end as shown at 150 and terminates at surface 160 along the bottom side of the mold cavity. The lowest portion of the mold cavity is shown at 170. This is also referred to as the nadir of the mold cavity. Extending backwardly from this nadir section is a first backleg 176 and a connecting second backleg cavity structure 178. An apex section 184 is provided as the upper section of the mold cavity structure with a corresponding nadir mold cavity shown at 182 at the lowest point of the cavity structure.

In accordance with conventional technology, a paint film 200 may be positioned along the female mold side of the cavity. A used herein, the phrase paint film is used generically to cover any decorative film that may be co-molded with the desired plastic. For example, the paint film may comprise a film laminate comprising plural layers which may include color, transparent, and/or metallic luster or metallic flake layers—all designed to impart the desired aesthetic appearance along the showside of the part. Alternatively, the paint film may comprise a single layer structure.

As shown, the paint film extends along the entirety of the show cavity 180 and one end thereof 206 terminates in the apex cavity with the bottom extremity 204 of the paint film terminating in the nadir cavity. As shown, the mold is a three-part mold with part lines designated as PL2, PL4, and PL6 respectively in phantom. A sprue 210 is provided in the male part in communication with the mold cavity. It is noted that a portion of the apex cavity is defined by top ledge connection 220 cavity having forwardly protruding ledge 202 with upper leg cavities 224 and 226 attached thereto.

Generally, the mold cavity comprises three major portions: (a) a major surface cavity 180, (2) a nadir cavity 182 and an apex cavity 184. As shown in FIG. 2, paint film 200 covers the showside (here the female side) of the show cavity and terminates at 204, 206 respectively in the nadir and apex cavity sections of the mold.

As shown in FIG. 2A and as is typical in some prior art methods, the edgewise extremity of the paint film 204 is disposed in the nadir cavity to the rear of the lowest portion of the cavity as designated by the reference numeral 170. This structure has proven troublesome in that withdrawal or drafting of the female mold member along vector line 110 as shown in FIG. 2A would often cause pinching or tearing of this portion 204 of the paint film.

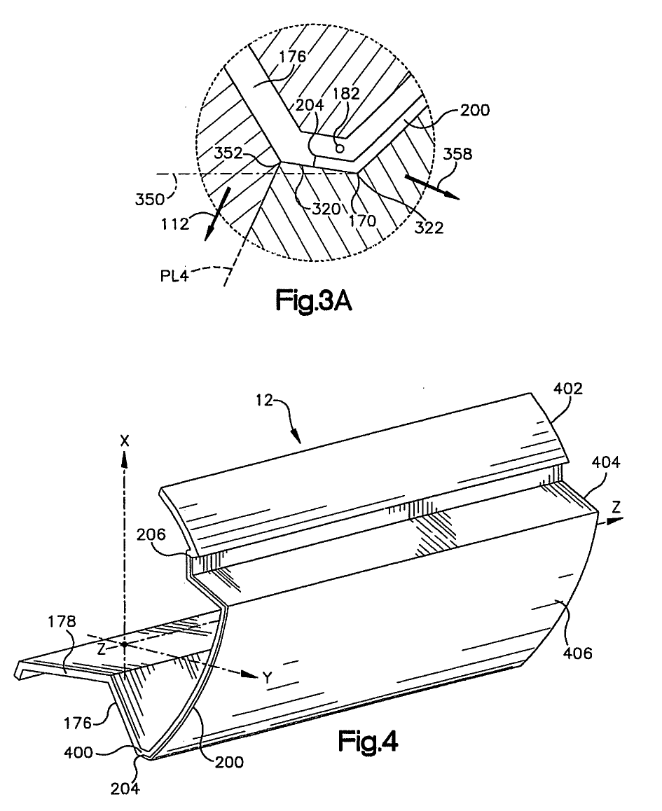

The present invention will be explained further in conjunction with FIGS. 3 and 3A hereof. In accordance with the mold structure shown in these figures, the nadir cavity section 182 of the mold is provided with a bottom wall surface that includes a bottom inclined wall 320 (FIG. 3A). The bottom wall 320 of the nadir cavity extends from a forward boundary 322 to the rear boundary 352. As shown in FIG. 3A, front boundary 322 of the bottom wall 320, creates an inclined angle of between about 1°-20°, preferably 1°-10°, and most preferably 5°, relative to a tangent 350 that touches front boundary 322 and is parallel to Y direction line 100 shown in FIG. 3 and is perpendicular to the X direction shown in FIG. 3. As shown, the bottom edge 204 of the paint film 200 extends along the bottom inclined wall 320 past the lowest extremity 170 of the mold cavity. The part line PL 4 in accordance with the invention is now located adjacent to the terminus 352 of the inclined wall 320.

As can be seen in FIG. 3, by reason of the provision of the inclined nadir cavity surface as shown best in FIG. 3A and the female die withdraw or draft vector as shown at 358 (FIG. 3), the part can be removed from the associated cavity while inhibiting pinching or scraping of the edge 204 of the paint film. Stated differently, the Y action withdraw or movement of the female mold member is also provided at an angle of about 1°-20° relative to the Y direction line shown at 100. This angle is substantially congruent to the angle noted above by which the bottom wall of nadir cavity is inclined. Also, as shown in FIG. 3, top ledge connection cavity 220 is also preferably inclined at this angle to facilitate Y direction movement of the female mold member away from the male mold member. In contrast, in the prior art structure shown in FIG. 2, the top ledge connection cavity 220 is substantially perpendicular to the X direction.

It is apparent that in accordance with one aspect of the invention, a method is provided for molding an elongated part having a substantially “C” shaped transverse cross section. Generally, the part comprises a nadir defining a bottom extremity of the part, an apex defining a top extremity of the part, and a major surface extending between the nadir and the apex and having a showside surface and opposing rear surface. In accordance with the method, a mold cavity congruent with the desired “C”-shaped transverse cross section is provided. The mold cavity itself extends along a longitudinal axis in the Z direction and includes a horizontal direction Y and a vertical direction X, with X, Y, and Z being perpendicularly related to one other. A nadir cavity, an apex cavity, and a major surface cavity are all provided in the cooperating mold structure with the major surface cavity having a front showside portion and an opposed rear portion. The nadir cavity, apex cavity, and major surface cavity, together, define the “C” or backwards “C” shape. A sloped bottom wall is provided in the nadir cavity with the sloped bottom wall having a forward boundary contiguous to the show surface of the major surface cavity and a rearward boundary extending away from the major cavity along the Y direction. The sloped bottom wall is provided at an angle of from about 1° to about 20° relative to a tangent line touching the forward boundary of the nadir cavity, extending in the Y direction and being perpendicular to the X direction.

The method comprises injecting molten plastic into the mold cavity, and allowing the molten plastic to cool to form the molded part. Then, the cooled plastic part is removed or ejected from the mold cavity and an acute angle relative to the X direction.

Typically, a paint film is placed in the mold cavity along the front showside surface of the major cavity with one edge of the paint film extending into the nadir cavity. As shown, the mold cavity is defined by a three-part mold structure comprising a stationary male member, a movable female member movable in the Y direction, and a slider section movable in the X direction. Removal of the molded part from the mold cavity includes movement of the female mold portion in the Y direction at an angle of about 1° to 20° relative to a line extending in the Y direction and parallel to the tangent line so that the edge of the paint film located in the nadir cavity is not scraped or pinched upon movement of the female mold member in the Y direction. Also, the slider member of the mold is moved in the X direction away from the male mold member.

Elongated automotive parts in accordance with the invention have a substantially “C” transverse cross-sectional shape. The part comprises a nadir wall portion defining the bottom extremity of the part, an apex wall portion defining a top portion of the part, and a major surface extending between the nadir wall portion and the apex wall portion. The major surface is provided with a showside surface and an opposing rear surface. The nadir wall portion extends away from the show surface of the major surface and has an inclined bottom wall surface. The bottom wall surface has a forward boundary contiguous to the major surface and a rearward boundary spaced from the major surface. The inclined wall is disposed at an angle of between about 1° to about 20° relative to a tangent line touching the forward boundary that extends in the Y direction in perpendicular disposition to the X direction. Preferably, this inclination is from about 1°-10° and most preferably is about 5°.

The automotive part, in its preferred embodiment, comprises a plastic substrate with a paint film covering the entirety of the showside surface and with a first edge of the paint film covering at least a portion of the nadir wall portion and terminating behind the forward boundary of the nadir portion. Also, the preferred embodiment includes a first edge of the paint film that terminates between the forward and rearward boundary along the inclined bottom wall of the nadir cavity. The second edge of the paint film covers at least a portion of the apex wall member.

What is claimed is:

1. In a method of molding an elongated automotive part having a substantially “C” shaped transverse cross sectional configuration, a nadir defining a bottom extremity of said part, an apex defining a top portion of said part, a major surface extending between said nadir and said apex and having a showside surface and an opposing rear surface, the improvement comprising:
(a) providing a mold cavity having at least two mold parts that, in operative association, define a space congruent with said “C” shaped transverse cross section, said mold cavity extending along a longitudinal axis in a Z direction and having a horizontal direction defined by an imaginary line Y and a vertical direction defined by an imaginary line X, with the Z direction, line Y, and line X being perpendicularly related to each other;
(b) providing a nadir cavity section, an apex cavity section, and a major surface cavity section in said mold cavity with said major surface cavity section having a front showside portion and an opposed rear portion, said nadir cavity section, apex cavity section and major surface cavity section, together defining said “C” configuration;
(c) providing a substantially linearly sloped bottom wall in said nadir cavity section, said sloped bottom wall having a forward boundary defining a junction of said sloped bottom wall and said major surface cavity section and a rearward boundary extending away from said forward boundary at a first angle of about 1° to about 20° relative to said line Y;
(d) injecting molten plastic into said mold cavity;
(e) allowing said molten plastic to cool to form said molded part; and
(f) separating said mold parts away from each other to remove said molded part from said mold cavity, said separating including providing relative movement of one mold part relative to the other along a second angle relative to said line Y that is substantially congruent to said first angle.

2. Method as recited in claim 1 wherein said first angle is from about 1° to about 10°.

3. Method as recited in claim 2 wherein said first angle is about 5°.

4. Method as recited in claim 1 wherein a paint film is placed in said mold cavity along said front showside surface of said major cavity and with one edge of said paint film extending into said nadir cavity section.

5. Method as recited in claim 4 wherein said mold cavity is defined by a three part mold structure, said mold cavity comprising a stationary male member, a moveable female mold member moveable along said second angle and a slidable section movable along an acute angle relative to said line X.

6. Elongated automotive part of the type having a substantially “C” or backward “C” transverse cross-sectional configuration, said part comprising a nadir wall portion defining a bottom extremity of said part, an apex wall portion defining a top portion of said part, and a major surface extending between said nadir wall portion and said apex wall portion and wherein said major surface has a showside surface and an opposing rear surface, said part extending in X, Y, and Z directions wherein Z is a longitudinal axis of said part, Y is a horizontal direction of said part, and X is a vertical direction of said part with X, Y and Z being perpendicularly oriented relative to one another, wherein said nadir wall portion extends away from said show surface of said major surface and has a substantially linear inclined bottom wall surface, said bottom wall surface has a forward boundary contiguous to said major surface and a rearward boundary spaced rearwardly from said major surface, said bottom inclined wall disposed at an angle of between about 1° to about 20° relative to said Y direction.

7. Elongated automotive part as recited in claim 6 wherein said angle is about 1° to 10°.

8. Elongated automotive part as recited in claim 6 wherein said nadir wall portion, major surface, and apex wall portion comprise a plastic substrate and wherein a paint film covers the entirety of said showside surface with a first edge of said paint film covering at least a portion of said nadir wall portion terminating behind said forward boundary.

9. Elongated automotive part as recited in claim 8 wherein said first edge of said paint film terminates between said forward and rearward boundary of said bottom wall surface.

10. Elongated automotive part as recited in claim 9 wherein a second edge of said paint film covers at least a portion of said apex wall portion.

11. Elongated automotive part as recited in 10 wherein said paint film is a laminate having a color layer therein.

12. Elongated automotive part as recited in claim 10 wherein said paint film is a laminate having at least one transparent layer.

13. Elongated automotive part as recited in claim 10 wherein said paint film comprises a metallic or metallic flake appearance.

14. Elongated automotive part as recited in claim 10 wherein said part is a side sill garnish.
